(19) United States
(12) Patent Application Publication
(10) Pub. No.: US 2024/0061629 A1
(43) Pub. Date: Feb. 22, 2024

(54) A NEW DEVICE DEVELOPED TO BE USED IN PRINTERS THAT PRINTS PLACED ORDERS AND PROVIDE EASE OF USE AND A SYSTEM OF THIS DEVICE

(71) Applicant: Telem SIMSEK, Etimesgut, Ankara (TR)

(72) Inventor: Telem SIMSEK, Etimesgut, Ankara (TR)

(21) Appl. No.: 18/248,083

(22) PCT Filed: Oct. 11, 2021
(86) PCT No.: PCT/TR2021/051034

§ 371 Date: Apr. 6, 2023

(30) Foreign Application Priority Data
Oct. 12, 2020 (TR) 2020/16182

(51) Int. Cl. G06F 3/12

(52) U.S. Cl. CPC G06F 3/126; G06F 3/1204; G06F 3/1297

(57) ABSTRACT

Disclosed is a device with an internet connection connected to the request of the ordering user, a non-local internet network provided by internet service providers, and a printer that can process print requests. Specifically, disclosed is a device developed to enable the printer that does not support internet network to accept the output request from the internet and print what is requested, and the order system that operates in harmony with this device. A server software is provided, and at least one microcontroller, which is an electronic device that supports connections such as USB, RS232, RJ45, used to connect to the printer with input and output units, a microcontroller and special program system that operates on a microcontroller, can transfer data with the server, and transfer the order information received to the printer.

### FIELD OF THE INVENTION

The present invention relates to a device and order system developed for the purpose of providing internet support for a printer without internet connection support, which enables the order to reach the responsible person who will prepare the order for the preparation of orders received by a mobile application, website or phone call and entered into the order system of the enterprises.

The present invention particularly relates to a device that is developed to allow the printer without internet support to accept the output request from the internet and print what is requested, and to an order system that operates with this device in a compatible manner.

### Present State of the Art

Today, corporations use POS (point of sale) systems so as to manage their orders, income expenses, customer records, stocks and other corporate operational needs. In order to prepare the received orders, they must be transmitted to the relevant personnel working in a certain physical part of the enterprise. An information slip containing customer and order information is printed so as to make this transmission healthy and to physically follow the preparation of the order and to deliver the same to the relevant customer when it is prepared. After the employee in charge prepares the order, they can deliver the order to the customer with the printed information slip.

There is a need for a desktop, tablet or similar system in which the drivers of the printers are installed so as to use the printers required to print the POS system and order details used in said process. Furthermore, it may be necessary to use said printers distal from each other in the enterprise. Printers and POS system must be installed on the same computer network so as to operate this structure work and to operate the printer integrated with the POS system. In order to realize this, the POS system and all its printers are connected to a network device (modem, switch, etc.) by wire or wireless and are set to receive an IP. Thus, a central POS system is sufficient for each printer.

Although this solution seems to function, since all devices are on the same network (LAN: local area network) and this network is closed to the outside; it brings an additional cost and/or management burden to businesses on issues such as;
the necessity for the smart phone, tablet or computer used by business managers and the employees and the modem or switch to which the printer is connected to the same network or the need for a second system for business managers to access reports and information required for business management, for employees to access order information
The necessity of the operation of the printers within a certain network or directly connected to the computer
The need for at least one desktop computer with the drivers of the printers installed in order to integrate with the order system in the enterprise
Emergence of a long installation process that requires modification, such as cabling when wireless expensive printers are not used, lack of a cheap and easy solution for businesses
Ordering from outside or inside the business with a smart phone, tablet or computer by the customers and using a second ordering system to print these orders instantly from printers and ensuring that the orders coming from here are entered into the POS system and printed.

The current situation is shown in FIG. 1

As seen in FIG. 1, at least one desktop computer with the printer drivers installed is required so as to print the order information given in the current applications. Cabling or using a relatively expensive wireless printer is required so as to establish the connection between the printer and the printer, other than to set up this computer. The current application is a device (1.2) which is a wired or wireless modem (1.7) used for local network and internet connection, a mobile phone, tablet or computer connected to the modem and to which the order information is entered consisting of local database (1.3) where order information is stored and cannot be queried without using a second software, computer (1.4) that manages the database and order information and has printer drivers installed, printer (8) connected to the order management system computer and used for printing, user (9) following orders and taking printouts, and the local network (1.1) created by all these components, in addition, optional internet connection (1.9) and internet service provider (1.8) providing internet connection.

In the Chinese patent application numbered CN201820296495, a receipt writing machine is disclosed. A completely different structure is disclosed in this receipt printer, which makes it easy to process receipts. This structure, which is not possible to communicate in an environment without internet, is insufficient to provide solutions to existing problems.

In order to provide this solution, a data channel circuit that can communicate to printers and a program that manages this circuit has been written on the microcontroller architecture, which is widely used in many areas today, and loaded into the microcontroller. Today's microcontroller architecture is shown in FIG. 2. The microprocessor (6) comprises the following; CPU (6.1.) that is called the central processing unit, manages other microcontroller units by performing logical mathematical operations, input and output ports (6.2) that enable data exchange with external equipment via various data paths (Wi-Fi, Bluetooth, etc.), counters (6.3) that store the number of occurrences of a given event or operation in relation to a clock signal and are used to count events that occur outside the microcontroller, timers (6.4) that count down from a specified time interval and are used to create a time delay, ROM (6.5) namely read-only memory that stores the program code and permanently stores the data used by the chip during program execution, RAM (6.6) namely random access memory that is data field used to temporarily store constant and variable values used by the microcontroller during normal program execution.

As a result, due to the abovementioned disadvantages and the insufficiency of the current solutions regarding the subject matter, a development is required to be made in the relevant technical field.

### Aim of the Invention

The aim of the invention is to eliminate the need for a driver-installed computer to print out from the printer by means of a device containing a microcontroller that receives the print request from the internet and sends it to the printer, a program containing commands that this device can receive, and a server system that manages the data exchange that this program can realize.

Another aim of the invention is to print from a printer without internet connection support by means of the device and server system containing a microcontroller.

Another aim of the invention is to provide a cheaper and easy-to-use device that eliminates the need to use an expensive printer that can connect to the internet to print orders received over the internet.

The invention aims to provide a structure having different technical features which brings a new development in this field different from the embodiments used in the state of the art.

In order to fulfill the above aims, the invention comprises the user placing the order, the device with internet connection, the internet network, the server system, the database, the microcontroller, the microcontroller system, the printer, the user receiving the printout.

In addition, in order to fulfill the above-mentioned purposes, the invention comprises the following process steps; making electrical or battery connections of the printer and microcontroller and connecting to the internet network, connecting the microcontroller connected to the printer automatically to the server and informing that it is ready and starting to listen to the communication channel opened by the server, registering the printers to be used in the system to the system that manages the orders and printers, the user's entering the order information into the system with a computer, tablet or smart phone. Saving this information by the order system via the Internet, the server's deciding on which printer to print according to the specified settings. The server's transmitting the output request to the channel that the decided printer and printers have listened to on the server. Receiving the output request of the microcontroller connected to the determined printer. Converting the output request into a data structure that the printer can understand by means of the microcontroller receiving the output request. The printer's printing the output as desired.

### DESCRIPTION OF THE FIGURES

FIG. 1 is a schematic view of current applications.

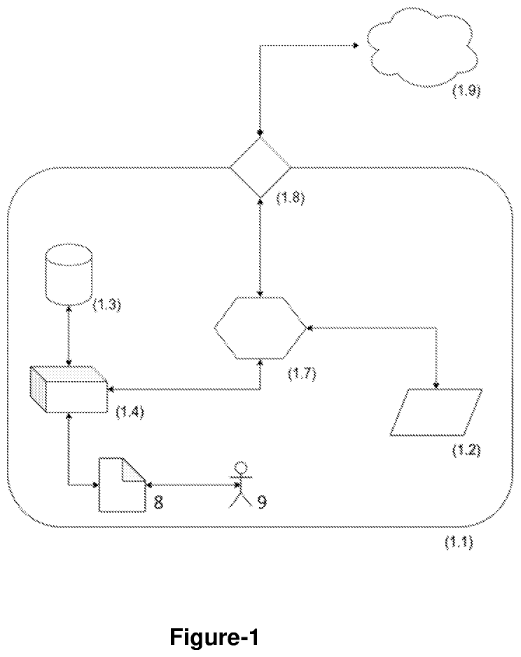

FIG. 2 is the view of the current microcontroller architecture.

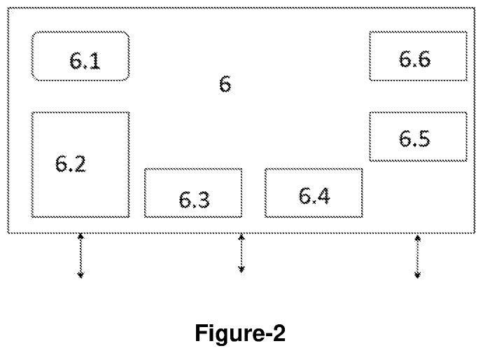

FIG. 3 is the schematic view of the inventive device and ordering system.

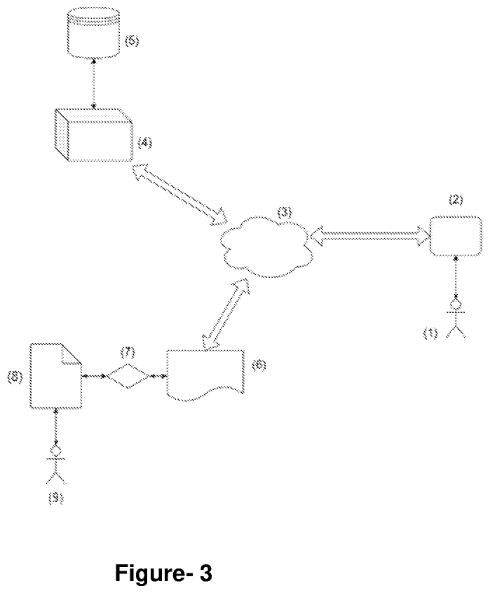

### DESCRIPTION OF THE PART REFERENCES

1. User placing order
1.1 local network
1.2 device
1.3 local database
1.4. computer
1.7. modem
1.8. internet service provider
1.9 internet connection
2. device with internet connection
3. internet network
4. server system
5. database
6. microcontroller
6.1. CPU
6.2. input and output ports (Wifi, Bluetooth, etc.)
6.3. counters
6.4. timers
6.5. ROM
6.6. RAM
7. microcontroller and special program system
8. printer
9. user receiving printout

### DETAILED DESCRIPTION OF THE INVENTION

In this detailed description, the preferred embodiments of the invention is described only for clarifying the subject matter in a manner such that no limiting effect is created.

The order information requested to be printed is sent to the printer (8) via the microcontroller (6), which is also connected to the Internet, over the internet (3) by using a device (2) (computer, tablet or smart phone) with an internet connection by the user (1) who has placed an order and thus, the requested order information is transmitted to the user (9) who receives the printout via the internet network (3).

The components of the invention that do not belong to the prior at consist of the following; server system (4), a microcontroller and a special program system (7) that can communicate with this server system (4), installed on the microcontroller (6), running automatically on the microcontroller (6) and enabling data exchange and printing commands between the microcontroller (6) and the printer (8) and printer (8) and microprocessor (6) that transmits the print request coming from the server to the printer (8), provides the communication between the printer (8) and the input and output ports (6.2) thereon via USB, RS232, RJ45 etc. ports and has input-output units such as Wi-Fi and Bluetooth.

Microcontroller (6) can supply its power from battery or electricity network. It starts to operate automatically when it receives electric current. It creates a certified secure connection between the server and the internet network (3) by means of the microcontroller and special program system (7) installed on it. The microcontroller (6) shares its single ID number with the server and is online with this connection. The server system (4) creates a record in the database (5) by using this information. It automatically selects the appropriate printer (8) by matching the order information and device information that is received with this record and sends the print request to the microcontroller (6). It is connected to the appropriate port of the printer using the appropriate data bus such as USB, RS232, RJ45 etc. provided by the microcontroller (6). After this point, the microcontroller (6) can understand the print requests sent by the server system (4) and can send a print command to the printer (8).

Furthermore, the server system (4) has the following abilities; it can manage certain settings of the microcontroller (6) connected to the printer, can follow the status of being connected or not, can automatically update the program it hosts can see if there is paper in the paper feed unit of the printer (8) and inform the users. Furthermore, it can automatically manage the sent orders regarding from which printer, when and how they will be printed out Users can adjust the system according to certain criteria by using the user interfaces of the server software. The order information to be printed is entered by the user (1) who placed the order and sent to the microcontroller (6) by the server system (4). It can perform all these operations by means of the microcontroller and special program system (7), which is specially written and loaded for the microcontroller (6).

The microcontroller and the special program system (7), which are written and loaded on the microcontroller (6), access and manage the printer (8) by exchanging data at the hardware level. This program is loaded into the ROM (6.5) part of the microcontroller (6).

It is possible to print out order information sent from any part of the world from a printer (8) in another part of the world, without being connected to the same network by means of this invention.

The printing device included in the invention can be directly connected to any printer (8) via serial connection methods such as USB, RS232, RJ45, etc. The microcontroller (6) communicates with the server that manages the print requests using an encrypted and certified secure connection by means of the input and output ports (6.2) added to its circuit. The server records the device as a client and tags it ready to send print commands. The server system (4), which can receive print requests, selects the appropriate client from its devices when order information or any other print request is received, and sends a print request to this client device. The client device receives this request and transmits it as a print command to the printer (8), which it is connected to, via the microcontroller and special program system (7).

1. A device that is developed to allow a printer without internet network support to accept the output request from the internet and print what is requested and an order system that operates with this device in a compatible manner comprising:
a device with at least one internet connection connected to the Internet, connected to the request of the user placing order,
a non-local internet network that is provided by internet service providers,
at least one printer that processes print requests from supported ports and prints on paper,
a server software which is the server computer of the system that processes the order information entered by the user who placed the order and decides which text to print according to the entered criteria
at least one microcontroller with an electronic device that supports connections such as USB, RS232, RJ45 used to connect to the printer with input and output ports
a microcontroller and a special program system that operates on the microcontroller, can transfer data with the server, and transfer the order information said microcontroller and special program system receives to the printer.

2. A system which:
decides that the server system will print out on which printer according to the specified settings,
prints the output from the printer as desired
which is developed to be used in printers that enable the writing of the given orders, providing ease of use
comprising the process steps of:
making electrical or battery connections of the printer and microcontroller and connecting to the internet network,
connecting the microcontroller connected to the printer to the server system automatically, giving the information that said system is ready and starting to listen to the communication channel opened by the server system,
registering the printers to be used in the system to the system that manages the orders and printers, transmitting the output request to the channel by the server system that the determined printer and printers transmitting the output request to the channel they have listened to in the server system,
receiving the printout request of the microcontroller connected to the determined printer, and
converting the printout request into a data structure that the printer can understand with the microcontroller receiving the output request, by means of the microcontroller and the special program system.
